(19) United States
(12) Patent Application Publication
(10) Pub. No.: US 2020/0159401 A1
(43) Pub. Date: May 21, 2020

(54) METHOD FOR PLANNING RESTRICTED FLY ZONE, FLIGHT CONTROL METHOD, SMART TERMINAL, AND CONTROL DEVICE

(71) Applicant: SZ DJI TECHNOLOGY CO., LTD., Shenzhen (CN)

(72) Inventors: Jianhuo SHAO, Shenzhen (CN); Shu WANG, Shenzhen (CN); Ruiyi ZHU, Shenzhen (CN)

(21) Appl. No.: 16/745,772

(22) Filed: Jan. 17, 2020

Related U.S. Application Data
(63) Continuation of application No. PCT/CN2017/093872, filed on Jul. 21, 2017.

(51) Int. Cl. G06F 3/0484; G05D 1/10

(52) U.S. Cl. CPC G06F 3/04847; G05D 1/106

(57) ABSTRACT

A method for planning a restricted fly zone, a flight control method, a smart terminal, and a control device are provided. The method of planning a restricted fly zone includes processing a map according to a pre-configured meshing scheme, tagging designated meshes in the map according to input information, and planning the restricted fly zone according to map areas associated with the tagged meshes. Areas beyond the restricted fly zone are a fly zone. This allows the restricted fly zone to be determined straightforward and quickly to facilitate subsequent flight control.

### CROSS-REFERENCE TO RELATED APPLICATION

This application is a continuation of International Application No. PCT/CN2017/093872, filed on Jul. 21, 2017, the entire content of which is incorporated herein by reference.

### TECHNICAL FIELD

The present disclosure relates to the technical field of flight control, and more particularly to a method for planning a restricted fly zone, a flight control method, a smart terminal, and a control device.

### BACKGROUND

With the opening of low-altitude airspace, small intelligent aerial devices, such as unmanned aerial vehicles (UAV), are getting popularized. These aerial devices may pose safety risks during flight to airports, special facilities, and sensitive constructions. Governments oftentimes designate restricted fly zones for special areas. These aerial devices may be restricted or completely prohibited in the designated restricted fly zones. Much research has been devoted to intuitively and quickly identifying information of a restricted fly zone.

### SUMMARY

One aspect of the present disclosure provides a method for planning a restricted fly zone. The method may include processing a map according to a pre-configured meshing scheme, tagging designated meshes in the map according to input information, and planning the restricted fly zone according to map areas associated with the tagged meshes.

Another aspect of the present disclosure provides a smart terminal. The smart terminal may include a processor and a memory. The memory is configured to be coupled to the processor and to store executable instructions therein. When the processor executes the executable instructions, the processor is configured to: process a map according to a pre-configured meshing scheme, tag designated meshes in the map according to input information, and determine the restricted fly zone according to map areas associated with the tagged meshes.

### BRIEF DESCRIPTION OF THE DRAWINGS

To more clearly describe the embodiments of the present disclosure or the technical solutions in the prior art, the drawings accompanied in the embodiments will be briefly described below. Apparently, the drawings in the following description are only some example embodiments. Those of ordinary skill in the art can obtain additional drawings based on these drawings without departing from the scope and the spirit of the present disclosure.

FIG. 1 is a schematic view of an interface showing a meshed map in accordance with various embodiments of the present disclosure;

FIG. 2 is a schematic view of an interface showing a meshed map with a reduced map scale, which is obtained based on the meshed map in FIG. 1;

FIG. 3 is a schematic view of an interface showing a meshed map with an enlarged map scale, which is obtained based on the meshed map in FIG. 1;

FIG. 4A is a schematic view of an exemplary meshed map in accordance with various embodiments of the present disclosure;

FIG. 4B is a schematic view of another exemplary meshed map in accordance with various embodiments of the present disclosure;

FIG. 4C is a schematic view of another exemplary meshed map in accordance with various embodiments of the present disclosure;

FIG. 5 is a schematic flow chart of an exemplary method for planning a restricted fly zone in accordance with various embodiments of the present disclosure;

FIG. 6 is a schematic flow chart of another exemplary method for planning a restricted fly zone in accordance with various embodiments of the present disclosure;

FIG. 7 is a schematic view of base meshes and corresponding sub-meshes on an exemplary map in accordance with various embodiments of the present disclosure;

FIG. 8 is a schematic flow chart of an exemplary method for controlling flight in accordance with various embodiments of the present disclosure;

FIG. 9 a schematic flow chart of another exemplary method for controlling flight in accordance with various embodiments of the present disclosure;

FIG. 10 is a schematic structural diagram of an exemplary smart terminal in accordance with various embodiments of the present disclosure;

FIG. 11 is a schematic structural diagram of an exemplary flight control device in accordance with various embodiments of the present disclosure;

FIG. 12 is a schematic structural diagram of an exemplary unmanned aerial vehicle in accordance with various embodiments of the present disclosure; and

FIG. 13 is a schematic structural diagram of an exemplary flight control device in accordance with various embodiments of the present disclosure.

### DETAILED DESCRIPTION

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The present disclosure provides a method of planning a restricted fly zone, a flight control method, a smart terminal, and a control device, which are capable of intuitively and quickly planning a restricted fly zone to facilitate subsequent flight controls.

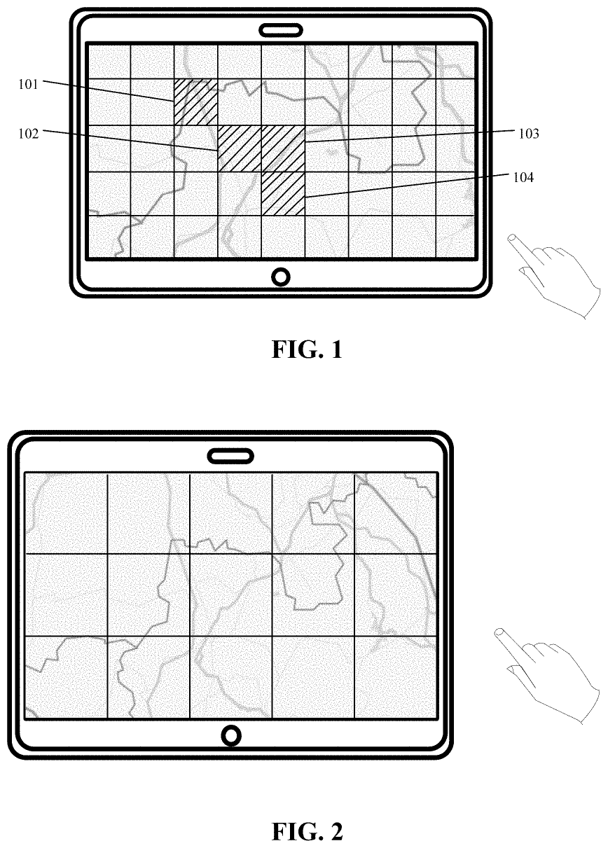

In the present disclosure, meshing airspace control primally refers to meshing an entire area displayed on a user interface, and associating in advance each mesh with a map area including information of the map area, and specifying a different code for each mesh. The code is referred to as a mesh code of the corresponding mesh. A mesh code uniquely defines a mesh. When planning a restricted fly zone, the meshes can be acted upon directly, for example, being clicked on and selected. The restricted fly zone can be determined by tagging the clicked and selected meshes and recording the mesh codes of those meshes. When a sensitive building needs to be added to a restricted fly zone, the meshes corresponding to the area in which the sensitive building is located can be directly selected and added to the restricted fly zone to obtain a new restricted fly zone. As shown in FIG. 1, it is a schematic view of an interface showing a displayed map having been meshed according to an embodiment of the present disclosure. After the displayed map is meshed according to a predetermined meshing scheme, the displayed map is overlaid with meshes having corresponding sizes.

A mesh code may include numeric numbers only, for example, the mesh codes can be numbered sequentially in an order of 1, 2, 3, . . . , n. In one embodiment, a mesh code can be given a practical meaning, and abbreviations of administrative divisions may be used to define the mesh code, such as CN-GD-SZ-XXX (China-Guangdong-Shenzhen-XXX), where XXX can be a numeric number. In one embodiment, a mesh code may also include an international telephone number along with other numeric numbers, for example, 0860755 XXX (China Shenzhen). Such numbering schemes allow for associating the meshes with the actual administrative areas, whereby an administrative area to which a mesh with a corresponding mech code belongs can be determined straightforward. In addition, such numbering schemes also allow for conveniently searching and locating the corresponding mesh codes. For example, if meshes associated with “Shenzhen” are to be searched, CN-GD-SZ can be entered for searching. In one embodiment, a mesh may be further coded based on a scale displayed on the map. For example, when the above mesh code scheme including numeric numbers is used to define the meshes associated with a target geographic area on a map including “Shenzhen”, the mesh codes can include a prefix 1100000 for a map scale of 1:100000 in addition to the numeric numbers. That is, the mesh code for the first mesh can be 11000001, the mesh code for the second mesh can be 11000002, and so forth.

In order to conveniently view a map displayed on a user interface, mesh display may be configured to be adjusted as needed. In one embodiment, a base mesh size may be defined, for example, a base mesh size of 1 cm by 1 cm can be defined for a geographical area of 1 km by 1 km. The meshes having the base mesh size are referred to as base meshes accordingly, for example, the meshes shown in FIG. 1 above. When the map is displayed with a specific map scale, the base mesh size can be dynamically resized according to that specific map scale to arrive at a new mesh size, and the meshes with the new mesh size are then displayed and overlaid on the map.

In one embodiment, when a map is displayed with a reduced map scale, a larger area is accordingly shown on the map, and the map can then be meshed with meshes of a larger mesh size to render a better mesh effect. For example, when a map scale of 1:100000 is reduced down to a map scale of 1:200000, a target mesh size of 2 cm by 2 cm can be achieved by enlarging the base mesh size of 1 cm by 1 cm, as shown in FIG. 2 which illustrates a meshed map obtained by reducing a map scale of the map in FIG. 1.

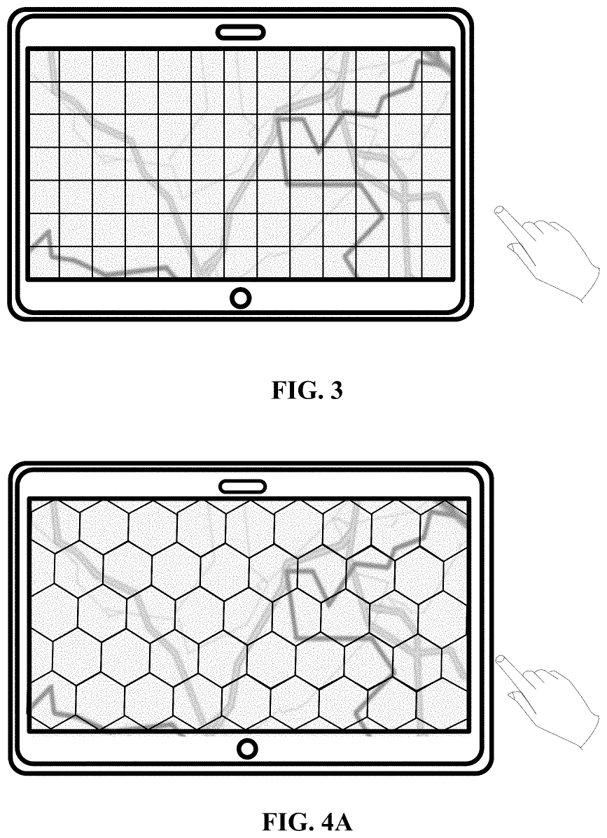

In one embodiment, when a map is displayed with an enlarged map scale, more details of local areas can accordingly be depicted on the map, and the map can then be meshed with meshes of a smaller mesh size to render a better mesh effect. For example, when a map scale of 1:100000 is enlarged to a map scale of 1:50000, a target mesh size of 0.5 cm by 0.5 cm can be achieved by reducing the base mesh size of 1 cm by 1 cm, as shown in FIG. 3 which illustrates a meshed map obtained by enlarging a map scale of the map in FIG. 1.

On the interfaces shown FIG. 1, FIG. 2 and FIG. 3, a restricted fly zone can be determined by clicking on meshes. The map area corresponding to the meshes selected by clicking will be designated as the restricted fly zone. For example, in FIG. 1, the map area corresponding to meshes 101, 102, and 103, which are colored with a designated color, is determined to be a restricted fly zone. The slashes in the meshes indicate that the meshes are assigned with a designated color. It will be appreciated that FIG. 1, FIG. 2 and FIG. 3 merely demonstrate illustrative meshes in different map scales according to embodiments of the present disclosure. In practice, when a map scale is changed, corresponding meshes can be precisely calculated based the base mesh size and then rendered. The meshes can also be displayed in different modes.

After a restricted fly zone is determined, each mesh associated with the restricted fly zone may be provided with a corresponding attribute identifier. The attribute identifier is configured to indicate whether a mesh is associated with a restricted fly zone. In one embodiment, the attribute identifier of the base mesh may be inherited by each sub-mesh of the base mesh, the attribute identifier of a sub-mesh of the base mesh may be inherited by each of its corresponding sub-mesh, and so forth. When operations are desired to perform on particular sub-meshes or sub-meshes at more lower layers, the attribute identifiers of those sub-meshes can be designated individually. For example, when the attribute identifier of a sub-mesh indicates that sub-mesh is associated with a restricted fly zone, the attribute identifier of that sub-mesh can be designated individually if that sub-mesh is clicked on and selected. That is, the attribute identifier of that sub-mesh can be modified to be an attribute identifier indicative of that sub-mesh not being associated with the restricted fly zone. An attribute identifier of a mesh is stored as the attribute information of that mesh. In addition to the attribute identifier, the attribute information of a mesh also includes the area content information included in the map area corresponding to that mesh. For example, if the area content information includes landmark building names, it indicates that the map area corresponding to that mesh includes landmark buildings.

In order to facilitate division of three-dimensional airspace, a same fixed map area on a map may be associated with different meshes at different altitudes. The mesh codes of the different meshes associated with the same fixed map area also differ. When numbering the meshes, altitude information may be taken into account, for example, adding altitude information as a prefix to the original mesh code. Whenever meshing a displayed map with a predetermined meshing scheme, the meshes ultimately displayed on the interface are meshes overlaid the displayed map at a same altitude (or within an altitude range). The restricted fly zone determined based on meshes also refers to a restricted fly zone at this altitude (or within the altitude range). For example, in the interface shown in FIG. 1 described above, the meshes may be meshes corresponding to an altitude of 1 km. After clicking on and selecting a plurality of meshes, the determined restricted fly zone, which includes the map area corresponding to the plurality of meshes, is referred to as a restricted fly zone within an altitude range of 1 km (i.e., the airspace below the altitude of 1 km). After setting the restricted fly zone at an altitude or within an altitude range, a user can enter a new altitude or altitude range on the user interface that displays the map. Based on the new altitude or altitude range, the map is being meshed again, whereby the user is able to set a restricted fly zone at the new altitude or with the new altitude range on the new interface including the new meshes and the map.

After setting a restricted fly zone, mesh codes at each altitude are stored. Based on mesh codes and their respective attribute identifiers, each mesh code is associatively stored with a fixed map area corresponding to the mesh indicated by that mesh code. A restricted fly zone can be determined subsequently based on the mesh codes. In one embodiment, a mesh code set is generated. Such mesh code set includes only mesh codes the attribute identifiers of which indicate the mesh codes are associated with a restricted fly zone. The mesh code set is then provided to an unmanned aerial vehicle. When flying the unmanned aerial vehicle, a map area is determined based on the mesh code set, which corresponds to meshes indicated by the mesh codes in the mesh code set, and a restricted fly zone or a flight zone can then be determined. In one embodiment, the mesh code set may also be provided to another terminal. Based on the mesh code set, that terminal can determines a map area corresponding to meshes indicated by the mesh codes in the mesh code set, and thereby determine a restricted fly zone or a flight zone. The determined restricted fly zone may be presented to a user on an interface of that terminal or may be for other uses.

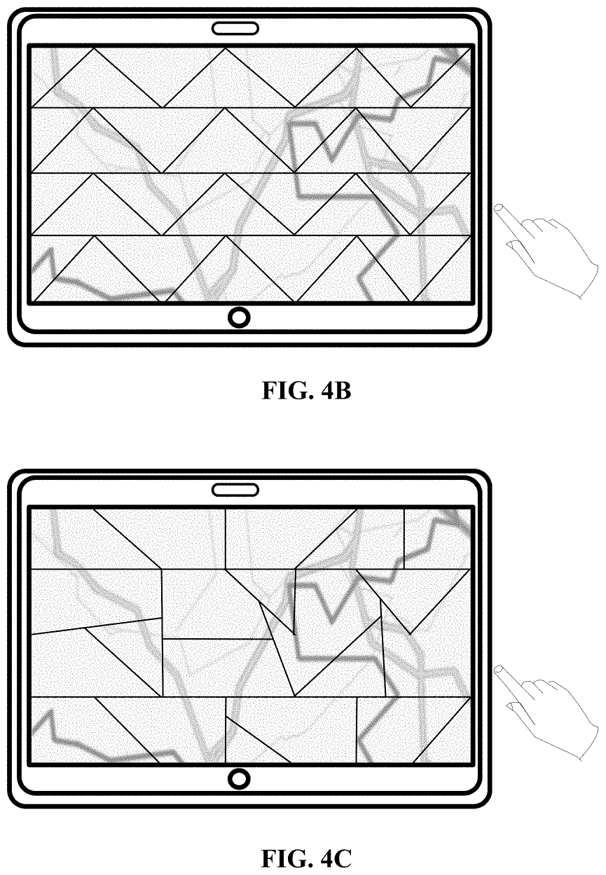

Meshes may be configured to vary in shape. In one embodiment, meshing an airspace may be based on local ground information, meshes of which may exhibit various shapes, for example, any type of polygonal, circular and/or irregular shapes. As shown in FIG. 4A, a schematic view is shown illustrating a meshed map in accordance with one embodiment of the present disclosure, which depicts a display interface having the map meshed with hexagons. As shown in FIG. 4B, a schematic view is shown illustrating a meshed map in accordance with another embodiment of the present disclosure, which depicts a display interface having the map meshed with triangles. Further, as shown in FIG. 4C, a schematic view is shown illustrating a meshed map in accordance with yet another embodiment of the present disclosure, which depicts a display interface having the map meshed with irregular shapes.

Numbering the meshes can vary and may take various modes. For example, the numbering scheme may be different for different mesh search techniques, and different numbering schemes may be applied to meet different mesh search time requirement. In the three-dimensional meshes, meshes may be coded based on a comprehensive consideration of both geographic location and altitude, to ensure that each mesh code only defines one mesh and each mesh corresponds to only one fixed map area.

A state of the meshed flight restriction control may be identified by assigning different colors on the displayed interface and may additionally be based on geographic information in this area. For example, the selected meshes as part of a restricted fly zone will be grayed out.

The meshes may be dynamically reduced or enlarged in size based on the map scale. By selecting a standard mesh size as a base mesh, meshes in different map scales can be dynamically displayed. After zooming the map, the corresponding meshes can also dynamically be displayed while the base meshes may not be displayed.

A sub-mesh can inherit the attribute identifier of a base mesh. After enlarging the map scale and the sub-mesh of the base mesh is displayed, the attribute identifier of the sub-mesh is defaulted as the attribute identifier of the base mesh. The attribute identifier of a sub-mesh of the base mesh may be inherited by each of its corresponding sub-mesh, and so forth. When the attribute identifiers of particular sub-meshes or sub-meshes at more lower layers are desired to be set individually, operations on such sub-meshes such as clicking and selecting can be performed, for example, by a user to individual meshes or sub-meshes.

The present disclosure allows users to set a restricted fly zone on a displayed map by meshing the displayed map, which renders the setting of a restricted fly zone intuitive and easy. In addition, the determined restricted fly zone is able to avoid unnecessary areas from being designated into the determined restricted fly zone, whereby a user of an unmanned aerial vehicle is facilitated to control the flight of the unmanned aerial vehicle while the restricted fly zone is guaranteed.

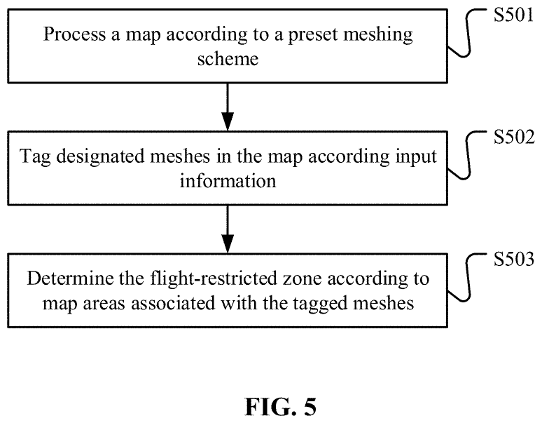

Referring to FIG. 5, a schematic flow chart of a method for planning a restricted fly zone is provided according to an embodiment of the present disclosure. The method may be implemented by a smart terminal. The smart terminal may be a smart terminal having a display, such as a smart phone, a tablet computer, a personal computer, and other terminals with display screens. The smart terminal may also be a dedicated control device with display screens. The method may include the following exemplary steps.

S501: meshing a map with a predetermined meshing scheme. The predetermined meshing scheme may include: instructions on processing parameters including mesh size and mesh shape when meshing the map; and instructions on processing meshes for parameters including altitude and map scale. The map can be displayed on a user interface. On the user interface, a user can perform touchscreen operations on the map, such as zooming the map, dragging the map, and so forth. In one embodiment, meshing the map based on a predetermined meshing scheme may include overlaying and displaying on the map meshes composed of polygons of a specified shape and size. Each mesh corresponds to a fixed map area on the map. In addition, when zooming the map, the sizes of the meshes can be adjusted accordingly. The resized meshes are new meshes each of which uniquely corresponds to a new fixed map area on the map.

S502: tagging the confirmed meshes according to input information. In an embodiment, the input information includes be mesh codes. The mesh codes may be mesh codes of selected meshes via clicks and selections performed on the displayed meshes after meshing the map in S501, for example, by touching the touch screen with a finger or the like to click on the meshes displayed on the user interface. The mesh codes may also be mesh codes of some meshes entered directly by a user. A mesh can be uniquely identified based on the mesh codes. The confirmed meshes above are then tagged. Tagging the confirmed meshes may include: performing color operations on the confirmed meshes on the displayed user interface to fill the confirmed meshes with the specified color(s); or setting in the backend the attribute identifiers of the confirmed meshes to the attribute identifiers indicative of the confirmed meshes being associated with a restricted fly zone. Apparently, other operations on the confirmed meshed may also be performed. Tagging the confirmed meshes is mainly to associate the confirmed meshes with the restricted fly zone.

S503: planning a restricted fly zone according to the map area associated with the tagged meshes. By associating all the tagged meshes with the restricted fly zone, the map area designated as the restricted fly zone can be displayed correspondingly on the user interface in the specified filling color. Further, the mesh code of each tagged mesh can be recorded and stored. Based on the recorded mesh codes, a restricted fly zone can be determined subsequently. A mesh code set consisting of the mesh codes of the tagged meshes can be transmitted to an unmanned aerial vehicle. The unmanned aerial vehicle is able to determine a flight zone and a restricted fly zone based on the mesh codes in the mesh code set, to facilitate the flight control.

The present disclosure may be used to facilitate users to set a restricted fly zone on a displayed map by meshing the displayed map, which renders the setting of a restricted fly zone intuitive and easy. In addition, the determined restricted fly zone is able to avoid unnecessary areas from being set into the determined restricted fly zone, whereby a user of an unmanned aerial vehicle is facilitated to control the flight of the unmanned aerial vehicle while the restricted fly zone is guaranteed.

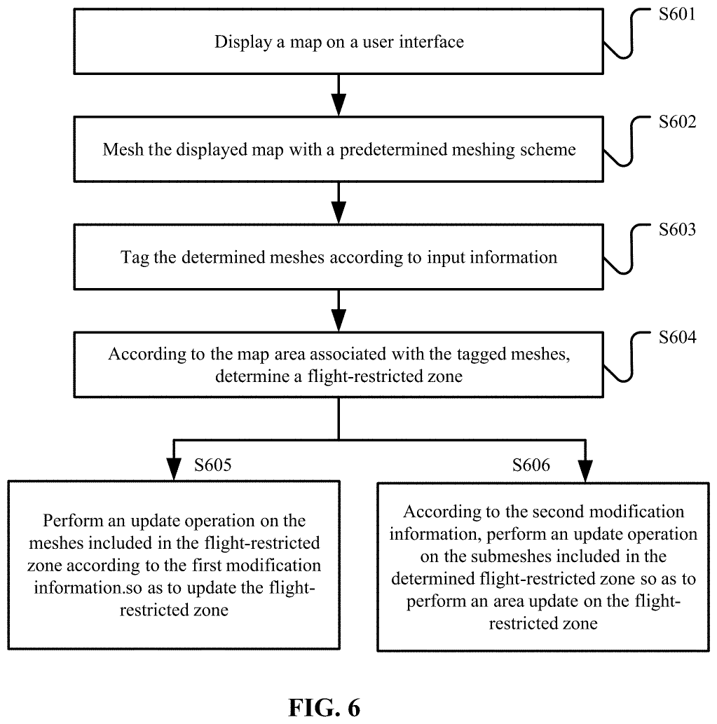

Referring to FIG. 6, a schematic flow chart of a method for planning a restricted fly zone is provided in accordance with another embodiment of the present disclosure. The method may be implemented by a smart terminal. The smart terminal may be a smart terminal having a display, such as a smart phone, a tablet computer, a personal computer, and other terminals with display screens. The smart terminal may also be a dedicated control device with a display screen. The method may include the following exemplary steps.

S601: displaying a map on a user interface. The user interface is configured primarily to display a map and to receive operations of a user, such as zooming out and zooming the map on the user interface. The user interface is also configured to display the meshes and to receive user operations such as clicking on and selecting meshes.

S602: meshing the displayed map with a predetermined meshing scheme. Each mesh is associated with a fixed map area in the map. After meshing the map, the meshes are correspondingly displayed on the user interface. Further, each mesh is provided with a mesh code, and each mesh code uniquely indicates a mesh. The mesh code of each mesh is associatively stored with a fixed map area associated with that mesh. The mesh code and the fixed map areas associated with that mesh can be transmitted to other devices, such as an unmanned aerial vehicle, whereby the unmanned aerial vehicle is able to subsequently determine a restricted fly zone and a flight zone based on the mesh code and the fixed map area associated with that mesh.

In addition, the map may be meshed based on a comprehensive consideration of both the map area and airspace altitude, and corresponding mesh codes are provided. In one embodiment, a same fixed map area in the map may be associated with different meshes at different altitudes. The mesh codes of different meshes associated with the same fixed map area are different. The different altitudes may refer to different altitude ranges.

In one embodiment, S602 may include: meshing the displayed map according to a mesh size specified in the predetermined meshing scheme. The meshing scheme may specify only one mesh size. When the meshing process is performed, all the final mesh sizes are the same. The mesh size can be preset. A base mesh size can be set first, and then the mesh size can be enlarged or reduced based on the base mesh size to obtain a new mesh size for the new meshes. Different mesh sizes correspond to different map display scales. The predetermined meshing scheme may specify a corresponding mesh size for each altitude and/or each map scale.

In one embodiment, S602 may include: performing a meshing process on the displayed map according to a mesh size and a mesh shape specified in the predetermined meshing scheme. That is, in addition to specifying the corresponding mesh size as described above, the predetermined meshing scheme may also configure the mesh shape. For example, the configured mesh shape may be square, rectangle, various polygons, or even may also be circle and irregular polygons. Based on the mesh size and mesh shape indicated by the predetermined meshing scheme, all map areas of the map need to be covered with the meshes when meshing the map, so that users can set up each map area as needed for a flight-restriction zone.

In one embodiment, S602 may include: determining a map zooming scale when the map is displayed on the user interface; determining a mesh size corresponding to the map zooming scale based on the predetermined meshing scheme; meshing the displayed map according to the meshes corresponding to the determined mesh size. That is, depending on the map zooming scale, the mesh size can vary. In other embodiments, the mesh size and/or shape may differ for different map zooming scales.

The determination of the mesh size corresponding to the map zooming scale includes determining the target mesh size according to the map zooming scale. The target mesh refers to a mesh size which is determined based on the base mesh size by enlarging or reducing the base mesh size according to the relationship between the map rooming scale and the base map scale. The relationship between the map zooming scale and the base map scale includes: zooming scale/base scale, which is a ratio between the two. For example, assuming a base scale being 1:100000, when the user increases the base scale to a zooming scale of 1:20000, the map can be determined to be magnified 5 times. When the map is determined to be magnified 5 times based on the zooming scale and the base scale (more details of the local area can be seen), the base mesh size is reduced accordingly to obtain a reduced mesh size, for example, from 1 cm by 1 cm being reduced to 0.2 cm by 0.2 cm. In one embodiment, the base mesh size may be preset or may be the mesh size indicated in the predetermined meshing scheme. The base meshes are determined based on the base mesh size. When the map is displayed at the base scale on the user interface, the displayed map is meshed according to the base meshes corresponding to the base mesh size.

S603: tagging the determined meshes according to input information. The input information includes mesh codes of the meshes selected by a first selection operation received on the user interface. The input information includes mesh codes of the meshes selected by a first selection operation received on the user interface.

S604: planning a restricted fly zone according to the map area associated with the tagged meshes. After planning the restricted fly zone, the map area in which the restricted fly zone is located is prompted on the user interface. The prompt of the map area is provided by changing the color of the meshes included in the restricted fly zone. Specifically, all the tagged meshes are designated as the restricted fly zone meshes, and the map area where the restricted fly zone is located can be displayed on the user interface in the designated filling color. The mesh codes of all the meshes covered by the determined restricted fly zone can be recorded.

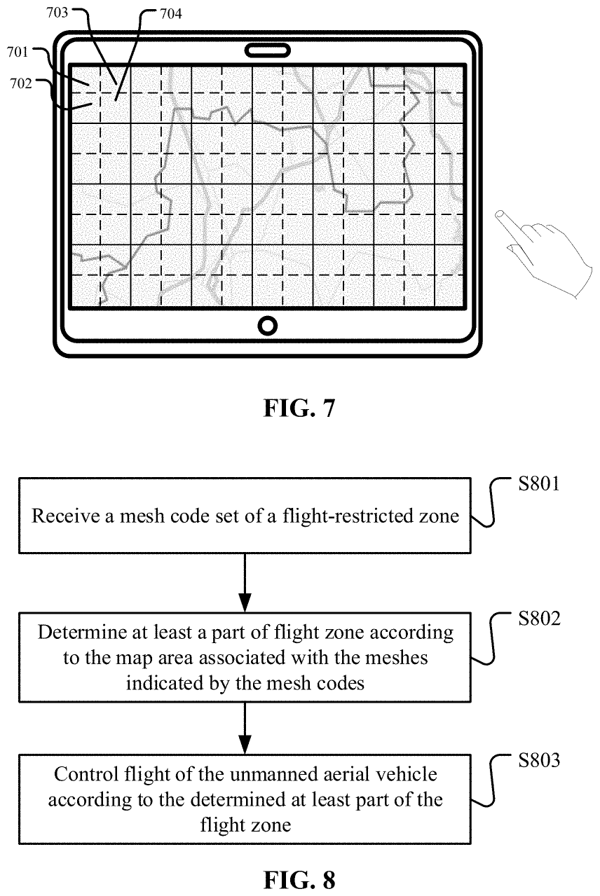

The attribute identifiers of all the meshes included in the restricted fly zone are configured to indicate the meshes to be the restricted fly zone meshes. When the map is enlarged with an enlarging map scale, the target mesh size can be determined based on the enlarging map scale. The meshes having the target mesh size are designated as sub-meshes corresponding to the base meshes. The attribute identifier of each sub-mesh is the same as the attribute identifier of the corresponding base mesh. The attribute identifier is configured to indicate whether the mesh is a restricted fly zone mesh. As shown in FIG. 7, the area enclosed by the solid lines is a base mesh, and the four meshes separated by two dashed lines are the sub-meshes of the base mesh. Specifically, a sub-mesh 701, a sub-mesh 702, a sub-mesh 703, and a sub-mesh 704 are shown, which correspond to one base mesh. The attribute identifier of each of the four sub-meshes is the same as the attribute identifier of the base mesh. If the attribute identifier of the base mesh indicates the base mesh to be a restricted fly zone mesh, then the attribute identifiers of the sub-mesh 701, sub-mesh 701, sub-mesh 703 and sub-mesh 704 are also automatically configured to be an attribute identifier indicative of the sub-meshes being the restricted fly zone meshes.

In some embodiments, after the restricted fly zone is determined, a user operation that can only be performed on the restricted fly zone mat also be received on the user interface. The restricted fly zone may also be further updated.

S605: performing an update operation on the meshes included in the restricted fly zone according to the first modification information so as to update the restricted fly zone. In one embodiment, S605 may include: receiving a second selection operation on the user interface, where the second selection operation refers to an operation on the meshes included in the determined restricted fly zone; determining the first modification information according to the second selection operation, where the first modification information includes the mesh codes of the meshes selected by the second selection operation; and tagging the meshes selected by the second selection operation according to the mesh codes.

In some embodiments, after the restricted fly zone is determined and the map displayed on the user interface is zoomed and displayed, a user operation on the sub-meshes can also be performed.

S606: according to the second modification information, performing an update operation on the sub-meshes included in the determined restricted fly zone so as to perform an area update on the restricted fly zone. A third selection operation is received on the user interface, where the third selection operation refers to an operation on the sub-meshes of the meshes included in the determined restricted fly zone. The second modification information is determined according to the third selection operation, where the second information includes the mesh codes of the sub-meshes selected by the third selection operation. And a tagging update is performed on the sub-meshes selected by the third selection operation according to the mesh codes of the sub-meshes. The sub-meshes refer to meshes determined by reducing the size based on the base mesh size.

The present disclosure may be used to facilitate users to set a restricted fly zone on a displayed map by meshing the displayed map, which renders the setting of a restricted fly zone intuitive and easy. In addition, the determined restricted fly zone is able to avoid unnecessary areas from being set into the determined restricted fly zone, whereby a user of an unmanned aerial vehicle is facilitated to control the flight of the unmanned aerial vehicle while the restricted fly zone is guaranteed.

An embodiment of the present disclosure also provides a non-transitory computer readable storage medium. The computer storage medium has operation instructions stored therein. When the operation instructions are executed, the methods shown in FIG. 5 or FIG. 6 can be performed to determine a restricted fly zone.

Referring to FIG. 8, a schematic flow chart of a method for controlling flight is provided according to an embodiment of the present disclosure. The method may be implemented by a smart terminal. The smart terminal may be a smart terminal having a display, such as a smart phone, a tablet computer, a personal computer, and other terminals with display screens. The smart terminal may also be a dedicated control device with a display screen. The smart terminal may be communicatively wirelessly connected to an unmanned aerial vehicle, to control the flight of the unmanned aerial vehicle. Apparently, the method may also be performed by an unmanned aerial vehicle (UAV), and the UAV performs autonomous flight control based on the method. The method may include the following exemplary steps.

S801: a mesh code set of a restricted fly zone is received, where the mesh code set includes multiple mesh codes, each mesh code is configured to uniquely indicate one mesh, and each mesh is associated with a fixed map area in the map. In one embodiment, the mesh code set in may only include particular mesh codes. These particular mesh codes may be mesh codes of the tagged meshes included in the restricted fly zone, or the attribute identifiers of the meshed defined by the mesh codes included in the mesh code set indicate the meshes to be the restricted fly zone meshes. In one embodiment, the mesh code set may include a mesh code subset including multiple target mesh codes. The map area corresponding to the meshes indicated by the multiple target mesh codes constitutes a restricted fly zone. Alternatively, the mesh code set may also include only mesh codes corresponding to the meshes tagged as flight zone meshes, so as to directly determine a flight zone for an unmanned aerial vehicle in the future.

S802: at least a part of flight zone is determined according to the map area associated with the meshes indicated by the mesh codes. According to the mesh codes of the restricted fly zone described above, the meshes corresponding to those mesh codes are excluded, and the rest of the meshes are designated as meshes of a non-restricted fly zone. The map area corresponding to the meshes of the non-restricted fly zone can be identified and defined as a flight zone. Each mesh code and its corresponding map area may be prestored.

S803: flight of the unmanned aerial vehicle is controlled according to the determined at least part of the flight zone. The unmanned aerial vehicle is controlled to fly in the flight zone and is prohibited to fly in the restricted fly zone. The unmanned aerial vehicle may also be allowed to fly with some restrictions in the restricted fly zone according to a prespecified flight restriction strategy. For example, the unmanned aerial vehicle is restricted to fly below a certain altitude.

In the embodiment of the present disclosure, the unmanned aerial vehicle or the smart terminal may receive and store a mesh code set related to the restricted fly zone set by a control terminal. The manner in which the control terminal determines a restricted fly zone can refer to the descriptions above.

In one embodiment, the method may further include: receiving a first restricted fly zone update request; and deleting corresponding mesh codes included in mesh code set of the restricted fly zone according to one or more mesh codes included in the first flight-restricted zone update request, thereby to complete updating the restricted fly zone. That is, some meshes may be modified by the user into non-restricted fly zone meshes. Therefore, the mesh code set can be updated by sending a first restricted fly zone update request.

In one embodiment, the method may further include: receiving a second restricted fly zone update request; according the sub-mesh codes of the sub-meshes included in the second restricted fly zone update request, determining the mesh codes of the base meshes of the sub-meshes corresponding to the sub-mesh codes; and replacing the mesh codes of the base meshes in the mesh code set of the restricted fly zone with the sub-mesh codes of the sub-meshes, thereby to complete updating the restricted fly zone. The sub-meshes refer to meshes determined by reducing the size based on the base mesh size. A detailed description of the sub-meshes can be referred to the descriptions in the foregoing embodiments. After a user modifies some of the sub-meshes into non-restricted fly zone meshes, the user may update the mesh code set by sending a second restricted fly zone update request.

The present disclosure is able to directly determine a flight zone and a corresponding restricted fly zone based on mesh codes. It is convenient for a user to set a restricted fly zone on the displayed map by means of meshes, whereby rendering the setting of a restricted fly zone straightforward and easy to operate. Therefore, a restricted fly zone can be set more accurately. When an UAV is flying, it can quickly determine a flight zone based on the mesh codes, which is convenient for a user of the UAV to control the flight of the UAV.

An embodiment of the present disclosure also provides a non-transitory computer readable storage medium. The computer storage medium has operation instructions stored therein. When the operation instructions are executed, the flight control method of an UAV as shown in FIG. 8 can be implemented.

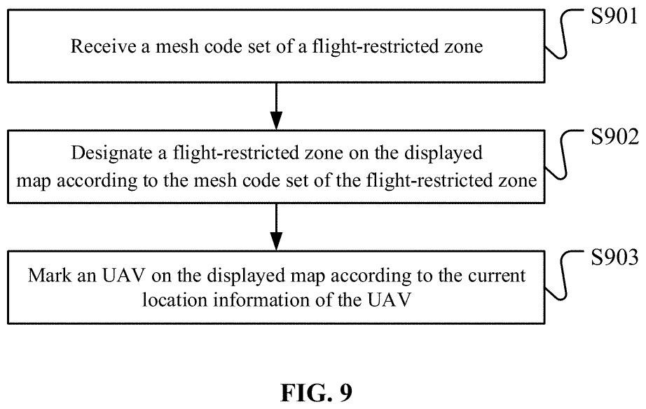

Referring to FIG. 9, a schematic flow chart of a method for controlling flight is provided according to another embodiment of the present disclosure. The method may be implemented by a flight control device. The flight control device may be a terminal having a display, such as a smart phone, a tablet computer, a personal computer, and other terminals with display screens. The flight control device may also be a dedicated control device with a display screen. The method may include the following exemplary steps.

S901: a mesh code set of a restricted fly zone is received, where the mesh code set includes multiple mesh codes, each mesh code is configured to uniquely indicate one mesh, and each mesh is associated with a fixed map area in the map. In one embodiment, the mesh code set may only include particular mesh codes. These particular mesh codes may be mesh codes of the tagged meshes included in the restricted fly zone, or the attribute identifiers of the meshed defined by the mesh codes included in the mesh code set indicate the meshes to be the restricted fly zone meshes. In one embodiment, the mesh code set may include a mesh code subset including multiple target mesh codes. The map area corresponding to the meshes indicated by the multiple target mesh codes constitutes a restricted fly zone. Alternatively, the mesh code set may also include only mesh codes corresponding to the meshes tagged as non-restricted fly zone meshes, so as to directly determine a flight zone for an unmanned aerial vehicle in the future.

S902: a restricted fly zone is designated on the displayed map according to the mesh code set of the restricted fly zone, where the restricted fly zone refers to the map areas associated with the meshes indicated by each mesh code. According to the correspondence between the mesh code and the map area, the map area corresponding to each mesh code is searched and confirmed, and then the map area is tagged. A designated restricted fly zone as shown in FIG. 1 is indicated by the slashes. In one embodiment, the tagging manner may be an manner in which the display color of the determined map area is adjusted to be a specified display color, for example, using a gray color to display each determined map area, whereas the untagged map areas may be displayed in a regular map color other than the gray color.

S903: an UAV is marked on the displayed map according to the current location information of the UAV. The UAV can communicate with the flight control device wirelessly and send the location coordinates of the UAV in real time. An icon of the UAV can be superimposed and displayed on the displayed map according to the location coordinates, for example, an “paper plane” icon displayed on the displayed map.

In one embodiment, when an update request is received, the designated restricted fly zone in the displayed map can be updated according to the update request. The update request may include mesh codes. Updating the designated restricted fly zone in the displayed may include removing the tags of the meshes in the restricted fly zone indicated by the mesh codes in the update request. The mesh code included in the update request may be a mesh code of a base mesh or a mesh code of a sub-mesh. According to these mesh codes, corresponding map areas are identified, and the display mode of these map areas is updated. For example, the map area displayed in gray can be updated to the map area displayed in regular map colors.

In one embodiment, when it is detected that a distance between the UAV and the restricted fly zone is less than a preset distance threshold, an alarm prompt is issued. The alarm prompt can be sound, light, electrical, and mechanical vibration prompts.

It should be noted that, for specific implementation of some features in each step in the embodiments of the present disclosure, references may be made to the descriptions in the foregoing embodiments, and details are not described herein.

The present disclosure is able to directly determine a restricted fly zone and a corresponding flight zone, which can intuitively demonstrate for users the relative location relationship between an UAV and a restricted fly zone. This allows a user to better control the flight of an UAV in a flight zone, improving flight safety.

An embodiment of the present disclosure also provides a non-transitory computer readable storage medium. The computer storage medium has operation instructions stored therein. When the operation instructions are executed, the flight control method of an UAV as shown in FIG. 9 can be implemented.

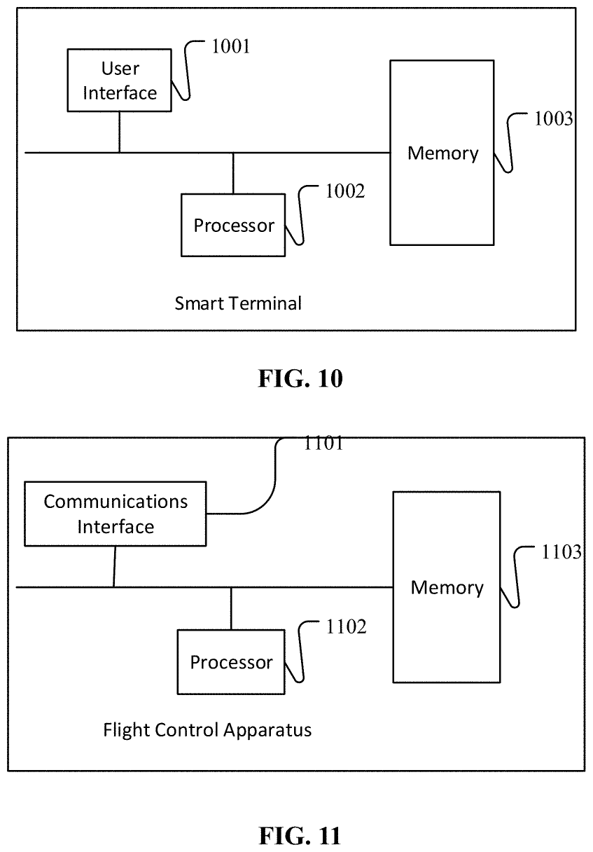

Referring to FIG. 10, a schematic structural diagram of a smart terminal is provided according to an embodiment of the present disclosure. The smart terminal may include a power module, various housing structures, buttons, and other structures as needed. The smart terminal may further include: a processor 1002 and a memory 1003. In some embodiments, the smart terminal may also include a user interface 1001. The user interface 1001, the processor 1002, and the memory 1003 are connected to each other, and data can be transmitted between them.

The user interface 1001 may be a touch screen display, physical keys, or an interface for receiving a user operation sent by a device such as a mouse. In one embodiment of the present disclosure, the user interface 1001 is a touch screen display. The touch screen display may be configured to display a user interface for displaying a map, to receive a user operation on the user interface, and to transmit the corresponding time of the user operation to the processor 1002. The memory 1003 may include volatile memory, such as a random-access memory (RAM). The memory 1003 may also include non-volatile memory, such as flash memory, a hard disk drive (HDD), or a solid-state drive (SSD). The memory 1003 may further include various combinations of memories of the above-mentioned types.

The processor 1002 may be a central processing unit (CPU). The processor 1002 may further include a hardware chip. The hardware chip may be an application-specific integrated circuit (ASIC), a programmable logic devices (PLD) or a combination thereof. The PLD may be a complex programmable logic devices (CPLD), a field-programmable gate array (FPGA), a generic array logic (GAL), or any combination thereof.

In one embodiment, the memory 1003 may further be configured to store executable instructions. The processor 1002 may call the executable instructions to implement the methods of planning a restricted fly zone as shown in FIG. 5 and FIG. 6.

In one embodiment, when the processor executes the executable instructions, the processor 1002 is configured to process the map according to a pre-configured meshing scheme; tag the determined meshes according to input information; and determine a restricted fly zone according to the map areas associated with the tagged meshes. The mesh codes corresponding to the meshes included in the restricted fly zone can be stored in the memory 1003.

In one embodiment, the processor 1002 is configured to: display a map on the user interface when the map is being processed according to a pre-configured meshing scheme; and mesh the map according to the pre-configured meshing scheme, where each mesh is associated with a fixed map area in the map. The mesh codes of the meshes and the corresponding map areas associated with the meshes can be stored in the memory 1003.

In one embodiment, the input information may include mesh codes of the meshes selected by a first selection operation received on the user interface. The first selection operation is transmitted via the user interface 1001 to the processor 1002.

In one embodiment, the processor 1002 is further configured to: set mesh codes, where each mesh code is used to uniquely indicate a mesh; and associatively store in the memory 1003 each mesh and a map area corresponding to that mesh.

In one embodiment, the same fixed map area in the map is associated with different meshes at different altitudes, and the mesh codes of the different meshes associated with the same fixed map area are different.

In one embodiment, the processor 1002 is configured specifically to, when performing meshing the displayed map according to a pre-configured meshing scheme, perform meshing the displayed map with the mesh size specified in the pre-configured meshing scheme. The user interface 1001 is configured to display a post-meshing image including the map and a plurality of meshes overlying the map.

In one embodiment, the processor 1002 is configured specifically to, when performing meshing the displayed map according to a pre-configured meshing scheme, perform meshing the displayed map with the mesh size and the mesh shape specified in the pre-configured meshing scheme. The user interface 1001 is configured to display a post-meshing image including the map and a plurality of meshes overlying the map.

In one embodiment, the processor 1002 is configured specifically to: when performing meshing the displayed map according to a pre-configured meshing scheme, determine a map zooming scale of the map being displayed on the user interface; determine a mesh size corresponding to the map zooming scale according to the pre-configured meshing scheme; and perform meshing the displayed map with the meshes having the determined mesh size. The user interface 1001 is configured to display a post-meshing image including the map and a plurality of meshes overlying the map.

In one embodiment, the processor 1002 may be configured to: set a base mesh size, where the base mesh size is used to determine base meshes; and when the map is displayed on the user interface at a base map scale, perform meshing the displayed map with the base meshes having the base mesh size. The user interface 1001 is configured to display a post-meshing image including the map and a plurality of meshes overlying the map.

In one embodiment, the processor 1002 may be configured to: when determining a mesh size corresponding to the map zooming scale, determine a target mesh size according to the map zooming scale, where the target mesh size is a mesh size determined by enlarging or reducing based on the base mesh size according to the relationship between the map zooming scale and the base map scale.

In one embodiment, when the target mesh size is a mesh size determined through size reduction based on the base mesh size, the meshes determined by the target mesh size are sub-meshes of the base meshes in the corresponding map area. The attribute identifier of each sub-mesh is the same as the attribute identifier of a base mesh corresponding to that sub-mesh. The attribute identifier of a mesh indicates whether that mesh is a mesh in the restricted fly zone.

In one embodiment, the processor 1002 may be configured to update meshes corresponding to the restricted fly zone according to the first modification information, thereby to perform area update on the restricted fly zone.

In one embodiment, the processor 1002 may be configured to: when updating the meshes in the restricted fly zone according to the first modification information, receive a second selection operation on the user interface, where the second selection operation refers to an operation on meshes included in the determined restricted fly zone; determine the first modification information according to the second selection operation, where the first modification information includes mesh codes of the meshes selected by the second selection operation; and according to the mesh codes, un-tag the meshes selected by the second selection operation. The second selection operation is received by the user interface 1001 and transmitted by the user interface 1001 to the processor 1002.

In one embodiment, the processor 1002 may further be configured to update sub-meshes included in the meshes of the restricted fly zone according to the second modification information, thereby to perform area update on the restricted fly zone.

In one embodiment, the processor 1002 may be configured to: when updating sub-meshes included in the meshes of the restricted fly zone according to the second modification information, receive a third selection operation on the user interface, where the third selection operation refers to an operation on the sub-meshes of meshes included in the determined restricted fly zone; determine the second modification information according to the third selection operation, where the second modification information includes sub-mesh codes of the sub-meshes selected by the third selection operation; and according to the sub-mesh codes, update tags of the sub-meshes selected by the third selection operation. The third selection operation is received by the user interface 1001 and transmitted by the user interface 1001 to the processor 1002.

In one embodiment, the sub-meshes refers to meshes determined by size reduction based on the base mesh size.

In one embodiment, the processor 1002 may further be configured to prompt on the user interface about an area in which a restricted fly zone is located, where the prompt is completed by changing a color of the meshes included in the restricted fly zone. The user interface 1001 is configured to update and display the meshes after color setting.

It should be noted that, for specific implementation of the processor 1002 in the embodiments of the present disclosure, reference may be made to the description of corresponding content in the foregoing embodiments.

The present disclosure is able to facilitate users to set a restricted fly zone on a displayed map by meshing the displayed map, which renders the setting of a restricted fly zone intuitive and easy. In addition, the determined restricted fly zone is able to avoid unnecessary areas from being set into the determined restricted fly zone, whereby a user of an unmanned aerial vehicle is facilitated to control the flight of the unmanned aerial vehicle while the restricted fly zone is guaranteed.

Referring to FIG.11, a schematic structural view of a flight control device is provided according one embodiment of the present disclosure. The flight control device may include a power supply module, a variety of housing structures, keys, and so on. The flight control device may further include a processor 1102 and a memory 1103. The flight control device may also include a communication interface 1101. The communication interface 1101, the processor 1102, and the memory 1103 are connected to each other and can be in data communications with each other.

The communication interface 1101 may be a WiFi hotspot-based communication interface 1101, or a wireless communication interface 110 1 such as radio frequency communication. Based on the communication interface 1101, the smart terminal may be connected to a to-be-controlled UAV to control the flight of the UAV. The memory 1103 may include volatile memory 1103, for example, RAM; The memory 1103 may also include non-volatile memory 1103, such as flash memory 1103, HDD or SSD; the memory 110 3 may further include a combination of the memories 1103 of the above-mentioned types.

The processor 1102 may be a CPU. The processor 1102 may further include a hardware chip. Alternatively, the memory 1103 may be configured to store executable instructions. The processor 110 2 may call the executable instructions, to implement the flight control method as shown in FIG. 8.

In one embodiment, the processor 1102 is configured to call a program stored in the memory 1103 to obtain a mesh code set of a restricted fly zone, where the mesh code set includes multiple mesh codes, each of which uniquely indicates a mesh, and each mesh is associated with a fixed map area in the map; determine at least a part of a flight zone according to the map areas associated with the meshes respectively indicated by the mesh codes; and according to the determined at least a part of the flight zone, generate control commands for controlling the flight of the UAV, where the communication interface 1101 transmits the control commands directly to the UAV. The mesh code set of the restricted fly zone can be determined by configuring the restricted fly zone in the map through meshes on the smart terminal. For a specific implementation manner, reference can be made to descriptions of relevant content in the foregoing embodiments. The mesh code set of the restricted fly zone may also be received from other smart terminals. For example, the mesh code set of the restricted fly zone may be determined by the smart terminal in the other embodiment and sent to the smart terminal.

In one embodiment, the mesh code set may include a subset composed of multiple target mesh codes, where the map areas indicated by the multiple target mesh codes constitutes a restricted fly zone.

In one embodiment, the processor 1102 may be further configured to receive and store, through the communication interface 1101, a mesh code set related to a restricted fly zone designated by a control terminal. The mesh code set is stored in the memory 1103.

In one embodiment, the processor 1102 may be further configured to receive a first restricted fly zone update request through the communication interface 1101; and according to one or more mesh codes included in the first restricted fly zone update request, delete the mesh codes of the restricted fly zone corresponding to the one or more mesh codes to complete the update on the restricted fly zone.

In one embodiment, the processor 1102 may be further configured to receive a second flight-restriction zone update request through the communication interface 1101; according to the sub-mesh codes of the sub-meshes included in the second flight-restriction zone update request, determine the mesh codes of the base mesh corresponding to the sub-meshes having the sub-mesh codes; and replace the mesh codes of the base meshes in the mesh code set of the restricted fly zone with the sub-mesh codes of the sub-meshes, thereby to complete updating the restricted fly zone.

In one embodiment, the sub-meshes refer to meshes determined by size reduction based on the base mesh size.

It should be noted that, for specific implementation of the processor 1102 in one embodiment of the present disclosure, reference may be made to the description of corresponding content in the foregoing embodiments.

This embodiment of the disclosure is able to directly determine a flight zone and a corresponding restricted fly zone based on mesh codes. It is convenient for a user to set a restricted fly zone on the displayed map by means of meshes, whereby rendering the setting of a restricted fly zone straightforward and easy to operate. Therefore, a restricted fly zone can be set more accurately. When an UAV is flying, it can quickly determine a flight zone based on the mesh codes, which is convenient for a user of the UAV to control the flight of the UAV.

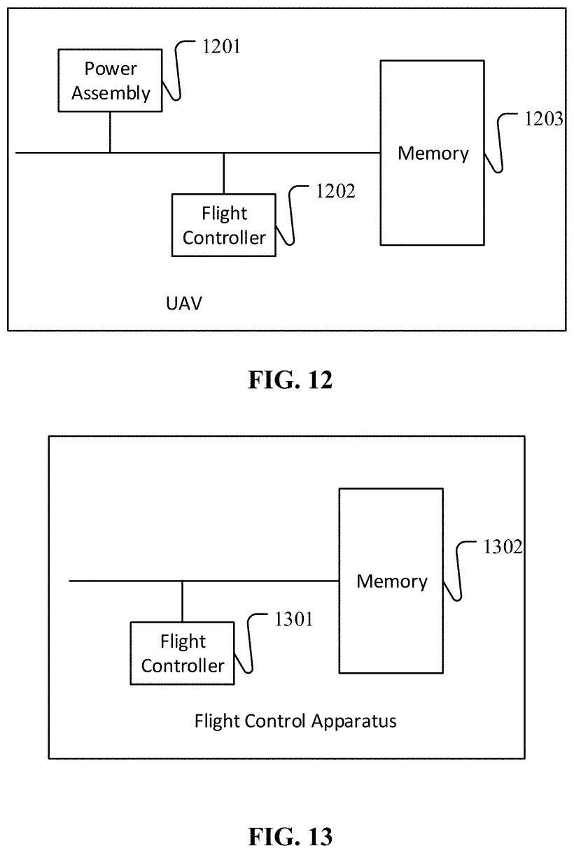

Referring to FIG. 12, a schematic structural diagram of an UAV is provided according to an embodiment of the present disclosure. The UAV may include a power supply, a housing structure and various loads, including, for example gimbal, camera and other loads. The UAV may also include a power assembly 1201, a flight controller 1202, a memory 1203, and a communication interface 1204. The UAV may be a fixed-wing UAV, and the UAB may also be a multi-rotor UAV such as a four-rotor UAV or a six-rotor UAV.

The communication interface 1204 is configured to communicate with other UAVs or smart terminals or remote controllers, and to receive corresponding data or control instructions, so as to facilitate the flight controller 1202 to control the flight of the UAV. The power assembly 1201 includes such structures as an electronic speed controller, a motor, and a propeller. The power assembly 1201 is configured to provide flight power.

The memory 1203 may include volatile memory 1203, for example, RAM; the memory 1203 may also include non-volatile memory 1203, such as flash memory 1203, HDD or SSD; the memory 1203 may further include a combination of memories 1203 of the above-mentioned types.

The flight controller 1202 may be a dedicated CPU. The flight controller 1202 may further include a hardware chip. The hardware chip may be an ASIC, a PLD, or a combination thereof. The PLD may be a CPLD, an FPGA, a GAL, or any combination thereof

In one embodiment, the flight controller 1202 is configured to obtain a mesh code set of a restricted fly zone, where the mesh code set includes multiple mesh codes, each of which uniquely indicates a mesh, and each mesh is associated with a fixed map area in the map; determine at least a part of a flight zone according to the map areas associated with the meshes respectively indicated by the mesh codes; and according to the determined at least a part of the flight zone, generate control commands that are transmitted to the power assembly 1201 for controlling the flight of the UAV.

In one embodiment, the mesh code set includes a code subset composed of multiple target mesh codes, and the map areas indicated by the multiple target mesh codes constitute a restricted fly zone.

In one embodiment, the flight controller 1202 may be configured to receive, through the communication interface 1204, a mesh code set of a restricted fly zone set by a control terminal. The flight controller 1202 may store the received mesh code set into the memory 1203.

In one embodiment, the processor 1202 may be further configured to receive a first restricted fly zone update request through the communication interface 1204; and according to one or more mesh codes included in the first restricted fly zone update request, delete the mesh codes of the restricted fly zone corresponding to the one or more mesh codes to complete the update on the restricted fly zone.

In one embodiment, the processor 1202 may be further configured to receive a second flight-restriction zone update request through the communication interface 1204; according to the sub-mesh codes of the sub-meshes included in the second flight-restriction zone update request, determine the mesh codes of the base mesh corresponding to the sub-meshes having the sub-mesh codes; and replace the mesh codes of the base meshes in the mesh code set of the restricted fly zone with the sub-mesh codes of the sub-meshes, thereby to complete updating the restricted fly zone.

In one embodiment, the sub-meshes refer to meshes determined by size reduction based on the base mesh size.

It should be noted that, for specific implementation of the processor 1202 in this embodiment of the present disclosure, reference may be made to the description of corresponding content in the foregoing embodiments.

This embodiment of the disclosure is able to directly determine a flight zone and a corresponding restricted fly zone based on mesh codes. It is convenient for a user to set a restricted fly zone on the displayed map by means of meshes, whereby rendering the setting of a restricted fly zone straightforward and easy to operate. Therefore, a restricted fly zone can be set more accurately. When an UAV is flying, it can quickly determine a flight zone based on the mesh codes, which is convenient for a user of the UAV to control the flight of the UAV.

Referring to FIG. 13, a schematic structural diagram of a flight control device is provided according to another embodiment of the present disclosure. The flight control device in this embodiment may include a power supply module, a variety of housing structures, keys, and other structures as necessary. The flight control device may further include a processor 1301, and a memory 1302 connected to the processor 1301.

The memory 1302 may include volatile memory, for example, RAM; the memory device 1302 may also include non-volatile memory, such as a flash memory, an HDD or an SSD; the memory 1302 may further include a combination of the memories of the aforementioned types. The processor 1301 may be a CPU. The processor 1301 may further include a hardware chip. The processor 1301 may call the executable instruction to implement the flight control method as shown in the embodiment of FIG. 9.

In an embodiment, when the processor 1301 executes the executable instructions, the processor 1301 is configured to receive a mesh code set of a restricted fly zone, where the mesh code set includes multiple mesh codes, each mesh code is configured to uniquely indicate one mesh, and each mesh is associated with a fixed map area in the map; designate the restricted fly zone on the displayed map according to the mesh code set of the restricted fly zone, where the restricted fly zone refers to the map areas associated with the meshes indicated by each mesh code; and mark an UAV on the displayed map according to the current location information of the UAV. The flight control device may further include a display screen, and the processor 1301 is configured to display the map and related information on the display screen.

In one embodiment, the mesh code set includes a subset composed of multiple target mesh codes, and the map area corresponding to the meshes indicated by the multiple target mesh codes constitute the restricted fly zone.

In one embodiment, the processor 1301 is configured to: when receiving an update request, update the designated restricted fly zone in the displayed map according to the update request. The update request includes mesh codes. Updating the designated restricted fly zone in the displayed may include removing the tags of the meshes in the restricted fly zone indicated by the mesh codes in the update request.

In one embodiment, when it is detected that a distance between the UAV and the restricted fly zone is less than a preset distance threshold, the processor 1301 is configured to issue an alarm prompt.

It should be noted that, for specific implementation of the processor 1301 in this embodiment of the present disclosure, reference may be made to the description of corresponding content in the foregoing embodiments.

This embodiment of the present disclosure is able to directly determine a restricted fly zone and a corresponding flight zone, which can intuitively demonstrate for users the relative location relationship between an UAV and a restricted fly zone. This allows a user to better control the flight of an UAV in a flight zone, improving flight safety.

The above disclosure is only part of the embodiments of the present invention, and the scope of rights of the present disclosure cannot be limited thereto. Therefore, equivalent changes made according to the claims of the present disclosure still fall within the scope of the present disclosure.

What is claimed is:

1. A method for planning a restricted fly zone, comprising:
processing a map according to a pre-configured meshing scheme;
tagging designated meshes in the map according to input information; and
planning to obtain the restricted fly zone according to map areas associated with the tagged meshes.

2. The method of claim 1, wherein processing the map according to the pre-configured meshing scheme comprises:
displaying the map on a user interface; and
meshing the displayed map according to the pre-configured meshing scheme, wherein each mesh is associated with a fixed map area in the map.

3. The method of claim 2, wherein the input information includes numbers of meshes selected in a first selection operation received on the user interface.

4. The method of claim 1, further comprising:
configuring mesh codes, each mesh code being configured to uniquely indicate a mesh; and
associatively storing a mesh code of each mesh and a map area associated with each mesh.

5. The method of claim 4, wherein configuring the mesh codes comprises:
obtaining an administrative area to which a map area belongs, the map area corresponding to each current mesh to-be-numbered; and according to a name of the administrative area, numbering each current mesh to-be-numbered to configure a mesh code for each mesh to-be-numbered; and/or
obtaining a map scale currently used by the map corresponding to each current mesh to-be-numbered, and according to the map scale, numbering each current mesh to-be-numbered to obtain a mesh code for each mesh to-be-numbered.

6. The method of claim 4, wherein a same fixed map area in the map is associated with a different mesh at a different altitude, and the different mesh associated with the same fixed map area has a different mesh code.

7. The method of claim 1, wherein meshing the displayed map according to the pre-configured meshing scheme comprises: meshing the displayed map according to a mesh size designated in the pre-configured meshing scheme.

8. The method of claim 1, wherein meshing the displayed map according to the pre-configured meshing scheme comprises: meshing the displayed map according to a mesh size and a mesh shape designated in the pre-configured meshing scheme.

9. The method of claim 1, wherein meshing the displayed map according to the pre-configured meshing scheme comprises:
determining a map zooming scale when the map is being displayed on the user interface;
determining a mesh size corresponding to the map zooming scale according to an instruction of the pre-configured meshing scheme; and
meshing the displayed map with meshes corresponding to the determined mesh size.

10. The method of claim 9, further comprising:
configuring a base mesh size, the base mesh size being configured to determine base meshes; and
when the map is displayed at a base map scale on the user interface, meshing the displayed map based on the base meshes corresponding to the base mesh size.

11. The method of claim 10, wherein determining the mesh size corresponding to the map zooming scale comprises:
determining a target mesh size according to the map zooming scale, wherein the target mesh is a mesh size determined by size enlargement or size reduction based on the base mesh size in accordance with a relationship between the map zooming scale and the base map scale.

12. The method of claim 11, wherein, when the target mesh size is a mesh size determined by size reduction based on the base mesh size, meshes determined based on the target mesh size are sub-meshes of the base meshes of corresponding map area, an attribute identifier of each sub-mesh is the same as an attribute identifier of a corresponding base mesh, and the attribute identifier is configured to indicate whether a mesh is included in the restricted fly zone.

13. A smart terminal, comprising:
a processor; and
a memory coupled to the processor and configured to store executable instructions therein,
wherein, when the processor executes the executable instructions, the processor is configured to:
process a map according to a pre-configured meshing scheme;
tag designated meshes in the map according to input information; and
plant to obtain the restricted fly zone according to map areas associated with the tagged meshes.

14. The smart terminal of claim 13, wherein the processor is further configured to:
display the map on a user interface; and
mesh the displayed map according to the pre-configured meshing scheme, wherein each mesh is associated with a fixed map area in the map.

15. The smart terminal of claim 14, wherein the input information includes numbers of meshes selected in a first selection operation received on the user interface.

16. The smart terminal of claim 13, wherein the processor is further configured to:
configure mesh codes, each mesh code being configured to uniquely indicate a mesh; and
associatively store a mesh code of each mesh and a map area associated with each mesh.

17. The smart terminal of claim 16, wherein the processor is further configured to:
obtain an administrative area to which a map area belongs, the map area corresponding to each current mesh to-be-numbered; and according to a name of the administrative area, number each mesh to-be-numbered to configure a mesh code for each mesh to-be-numbered; and/or
obtain a map scale currently used by the map corresponding to each current mesh to-be-numbered, and according to the map scale, number each current mesh to-be-numbered to obtain a mesh code for each mesh to-be-numbered.

18. The smart terminal of claim 16, wherein a same fixed map area in the map is associated with a different mesh at a different altitude, and the different mesh associated with the same fixed map area is assigned a different mesh code.

19. The smart terminal of claim 13, wherein the processor is further configured to mesh the displayed map according to a mesh size designated in the pre-configured meshing scheme.

20. The smart terminal of claim 13, wherein the processor is further configured to mesh the displayed map according to a mesh size and a mesh shape designated in the pre-configured meshing scheme.
